(19) United States
(12) Patent Application Publication
(10) Pub. No.: US 2021/0275375 A1
(43) Pub. Date: Sep. 9, 2021

(54) Gas-Filled Patient Positioner

(71) Applicant: EHOB, Inc., Indianapolis, IN (US)

(72) Inventors: Gregory R. Konkle, Indianapolis, IN (US); Alex Opell, Indianapolis, IN (US)

(21) Appl. No.: 17/193,488

(22) Filed: Mar. 5, 2021

Related U.S. Application Data
(60) Provisional application No. 62/985,619, filed on Mar. 5, 2020.

(51) Int. Cl. A61G 7/057

(52) U.S. Cl. CPC A61G 7/05769

(57) ABSTRACT

A gas-filled patient positioner for positioning a body part of a patient comprises a plurality of bladder structures mounted on top of and overlapping each other. Each bladder structure includes a pair of adjacent elongated gas-filled bladders with the inboard side of each of the bladders facing or abutting each other. At least one bleed channel extends transversely between and in communication with the adjacent pair of bladders. The plurality of bladder structures is tightly encased within an elongated outer covering that includes an array of seams that define channels in top and bottom surfaces of the covering to provide pathways for heat and moisture to escape. The array of seams includes a single seam extending along the length of the bladder structures and arranged over the bleed channel, and a plurality of transverse seams extending across a width of the top and bottom surfaces of the outer covering.

### PRIORITY CLAIM

This application is a utility filing from and claims priority to U.S. Provisional Patent Application No. 62/985,619, filed on Mar. 5, 2020, the entire disclosure of which is incorporated herein by reference.

### BACKGROUND

Patient positioners are widely used during surgeries, patient recovery and rehabilitation. The positioners are used to position, bolster and support the patient at nearly every part of the patient anatomy. For instance, positioners are widely used to support a patient's upper and lower back, neck, hips, knees and ankles.

The prevalent positioners are in the form of “sandbags”, namely elongated bodies of various sizes depending upon the part of the patient anatomy being supported and the size of the patient. The sandbags are filled with a gel that can provide support for the affected part of the body. The outer casing of the sandbags are typically a vinyl or polyurethane material that is impervious to body fluids. The outer casing aids in the overall rigidity of the sandbag when filled with the gel, providing significant support but at the cost of patient comfort. The typical sandbag positioner allows, at best, for only minimal immersion of the patient's body into the positioner, which can be uncomfortable for the patient during long term use. Consequently, there is a need for a patient positioner that comfortably supports the patient and relieves the pressure on the patient generated by the conventional gel-filled sandbags.

### SUMMARY OF THE DISCLOSURE

A gas-filled patient positioner for positioning a body part of a patient comprises a plurality of bladder structures mounted on top of and overlapping each other. Each bladder structure includes a pair of adjacent elongated gas-filled bladders with the inboard side of each of the bladders facing or abutting each other. At least one bleed channel is provided in communication between the pair of bladders, in which the bleed channel extends transverse to the length between the inboard sides of the bladders.

The patient positioner is further provided with an elongated outer covering configured for completely covering and tightly encasing the plurality of bladder structures. The outer covering includes an array of seams that define channels in top and bottom surfaces of the covering to provide pathways for heat and moisture to escape between the body part of the patient resting on the positioner and the outer surface. In one feature, the array of seams includes a single seam extending along the length of the bladder structures and arranged over the bleed channel, and a plurality of transverse seams extending across a width of the top and bottom surfaces perpendicular to the length, with the plurality of transverse seams spaced apart along the length.

In one aspect, the plurality of bladder structures includes upper, intermediate and lower bladder structures that directly overlap each other. The intermediate and lower bladder structures are air-filled at the same pressure, while the upper bladder structure is air-filled at a lower pressure.

### DESCRIPTION OF THE DRAWINGS

FIG. 1 is a perspective view of a gas-filled patient positioner according to the present disclosure.

FIG. 2 is side view of the patient positioner shown in FIG. 1.

FIG. 3 is an end view of the patient positioner shown in FIG. 1.

FIG. 4 is an enlarged top view of the patient positioner shown in FIG. 1.

FIG. 5 is a cross-sectional representation of the patient positioner shown in FIG. 1.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

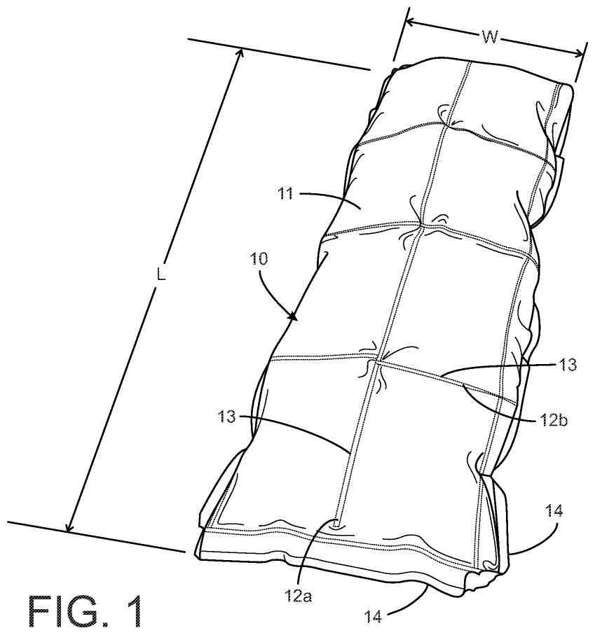

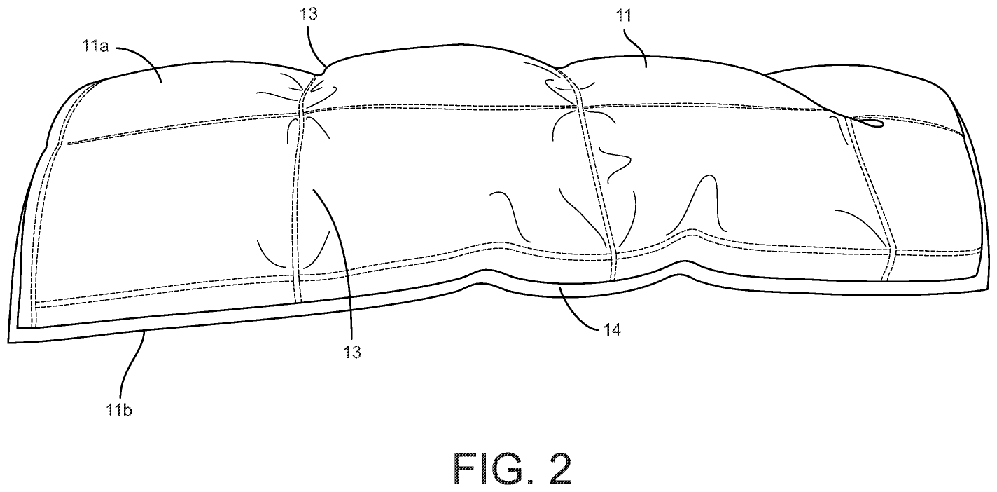

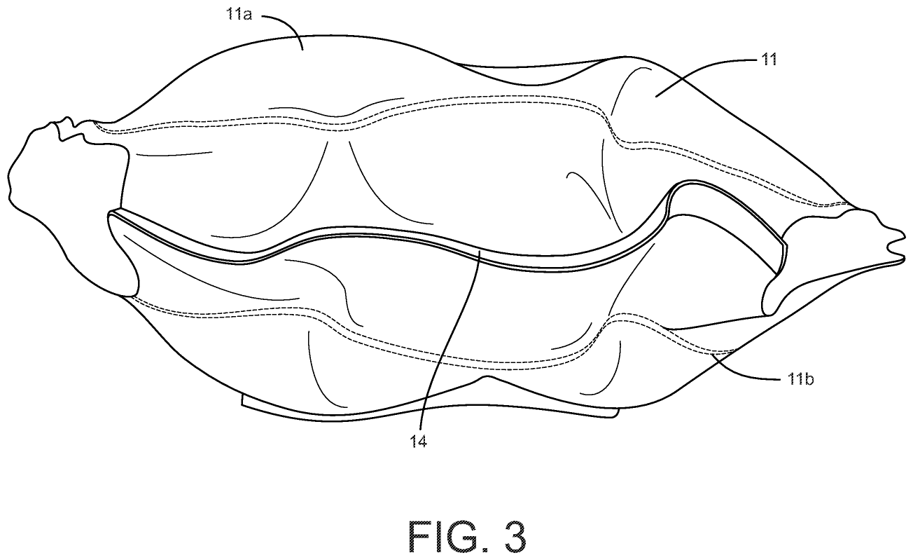

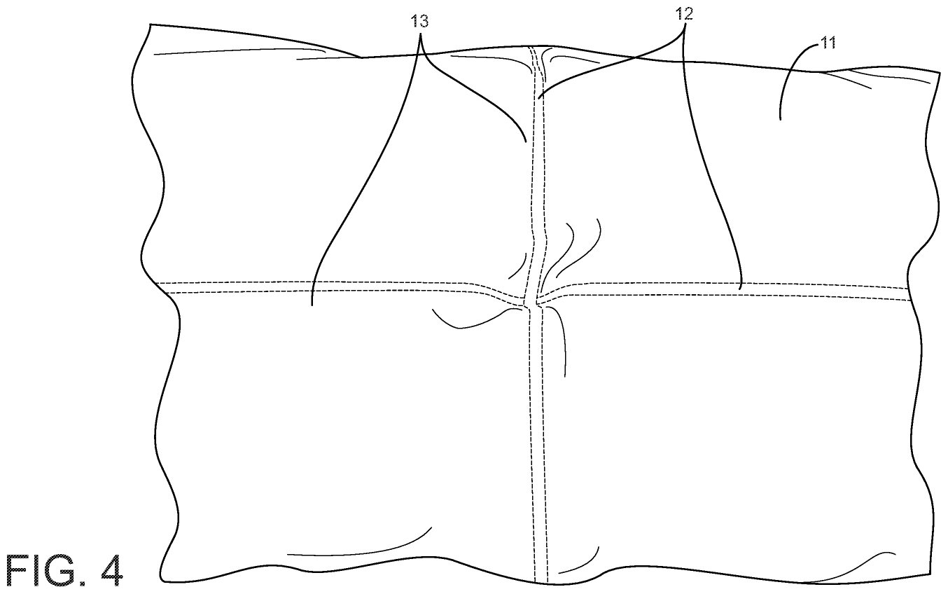

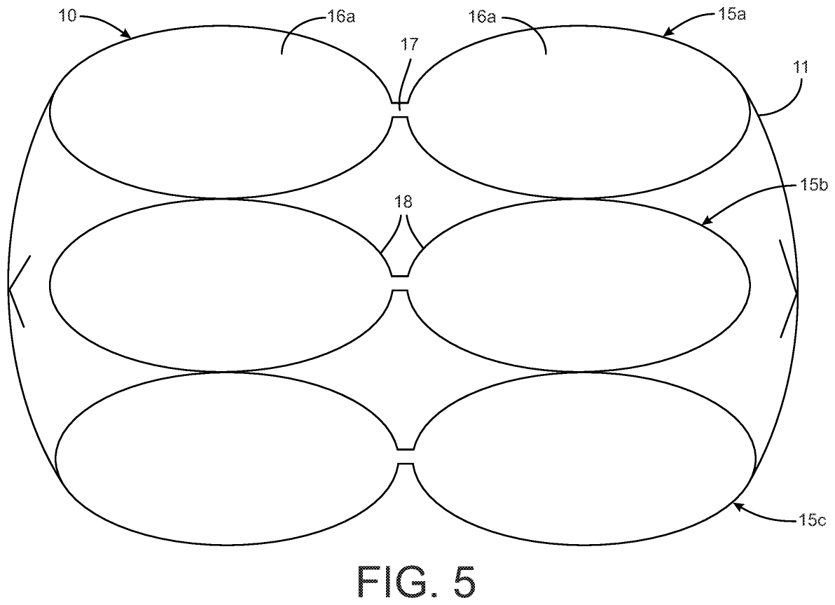

A gas-filled positioner 10 includes an outer covering 11 formed of a vinyl, nylon or polyurethane material, as shown in FIGS. 1-4. In one feature of the present disclosure, the outer covering includes an array of seams 12 formed in the top and bottom outer surfaces 11a, 11b of the covering that define channels 13, as best shown in FIG. 2. The channels provide pathways for heat and moisture to escape between the patient and the surface of the outer covering 11. The seams also delineate the location of bladder pairs 16a, 16b (FIG. 5) disposed along the length L of the positioner. In the illustrated embodiment, a single seam 12a extends along the length of the positioner, bisecting the width W. A plurality of transverse seams 12b are provided across the width of the positioner, spaced evenly along the length L, with four transverse seams in one embodiment. Outer seam(s) 14 delineates the perimeter of the positioner so that the outer covering 11 can be formed from two sheets of material tightly encasing the bladder pairs, one sheet forming the top surface 11a and the other sheet forming the bottom surface 11b. It can be appreciated that the positioner 10 can be provided in various lengths L and widths W depending upon the particular application of the positioner, with the bladder pairs appropriately sized. In certain embodiments, the length L is at least three times the width W. In a preferred embodiment for use in a hospital setting, the length is 18-30 inches and the width is 6-10 inches.

In one aspect of the disclosure, the positioner 10 includes three bladder structures, including an upper bladder structure 15a, an intermediate structure 15b and a lower bladder structure 15c, all of which are completely encased within the outer covering. Each bladder structure includes a pair of gas-filled bladders 16a, 16b arranged side-to-side across the width W of the positioner, or more particularly with their respective inboard sides 18 facing each other or in contact with each other. The bladder pairs are also mounted vertically on top of and overlapping each other. The bladders can be formed of an elastomeric material that can expand upon inflation and that can be depressed by weight of the patient's body. In specific embodiments, the bladders can be formed of PVC or other vinyl, polyurethane, or a laminated fabric such as nylon.

All of the bladders are inflated, with the outer covering tightly encasing the inflated bladder structures. In order to facilitate immersion of the part of the patient's body into the positioner, the upper bladder structure is inflated to a lower pressure than the other two bladder structures. This feature allows the patient's body to gradually sink into the positioner, while the lower two bladder structures provide the necessary support. This immersion feature greatly increases the comfort to the patient over the prior gel sandbag devices. In one specific embodiment, the bladders of the upper bladder structure 15a are all inflated to less than 0.5 psi, while the bladders of the lower two bladder structures 15b, 15c are all inflated to at least 0.5 psi. In certain embodiments, the lower bladders can be inflated to a predetermined multiple of the inflation pressure of the upper bladder structure.

The positioner 10 also includes a feature that allows the positioner to accept the patient's body in all possible orientations while still maintaining support. One problem associated with gas bladder structures is that the bladder can “balloon” at one end when the patient rests his/her leg, for example, on an opposite end of the bladder. This movement compromises the ability of the positioner to properly position and adequately support. In order to avoid this problem, the positioner 10 of the present disclosure utilizes pairs of bladders 16a, 16b at each level with one or more bleed channels 17 defined between the pair of bladders, as shown in FIG. 5. In one specific embodiment, the bleed channel(s) has a cross-sectional effective diameter of ⅛- 3/16 inches. In one embodiment, three bleed channels are evenly distributed along the length of the positioner 10 and extend transversely between the adjacent pairs of bladders. The bleed channel(s) 17 allows communication of gas from one bladder 16a to the other bladder 16b when the patient's limb is placed on the side of the first bladder 16a. However, as the first bladder 16a compresses and the second bladder 16b inflates, the bleed channel(s) provides a constricted and controlled gas flow between the bladders. Thus, rather than immediately ballooning, the two bladders 16a, 16b gradually find an equilibrium position in which the first bladder 16a is only slightly compressed and the second bladder 16b is only slightly inflated.

This feature of the positioner 10 allows the patient's body to gradually settle into the positioner, maintaining stability during the entire process. The bleed channel(s) 17 is provided between the bladders in each of the bladder structures 15a, 15b, 15c, with the cross-section of the bleed channel(s) being the same or different among the three levels. It can be appreciated that the upper bladder structure 15a will permit more immersion than the lower two structures because the upper bladder pair 16a, 16b is at a lower pressure than the other two bladder pairs. In one embodiment, each bladder pair 16a, 16b includes one, two or three bleed channels evenly distributed along the length of the bladders, although more bleed channels may be provided for positioners that are particularly long. The total cross-sectional area of the combined bleed channels can be calibrated to control the rate of gas flow from one bladder to the other. In one embodiment utilizing a single bleed channel, the cross-sectional area can be 0.1-0.15 sq.in. In other embodiments, the total cross-sectional area of the bleed channels can be 0.2-0.5 sq. in.

In one embodiment, the positioner 10 is completely sealed, meaning that the bladder structures do not include any inflation port. The bladders are completely sealed so that no gas can leak from the positioner, thereby compromising the function of the device. In one embodiment, the bladders are inflated with air. However, other inert gases may be used, such as nitrogen. In other embodiments, one or more of the bladder structures can include inflation ports to allow customization of the inflation pressures for patient-specific comfort.

As reflected in FIG. 1, the positioner 10 can include four bladder pairs along the length L of the positioner. With three vertical rows, the positioner includes a total of twelve pre-inflated bladders sealed within the outer covering 11. The interior seams 12 and channels 13 are thus aligned along the bleed channels 17 between bladder pairs, and at the lengthwise interface between bladders. It is contemplated that the bladder pairs are independently formed, with the vertical stack of bladder pairs being affixed to each other to maintain the stability of the positioner. The bladder pairs may also be affixed along the length of the positioner, although it is less likely that the bladder pairs will shift positions along the length of the positioner.

The present disclosure should be considered as illustrative and not restrictive in character. It is understood that only certain embodiments have been presented and that all changes, modifications and further applications that come within the spirit of the disclosure are desired to be protected.

What is claimed is:

1. A gas-filled positioner for positioning a body part of a patient, comprising:
a plurality of bladder structures mounted on top of each and overlapping other, each bladder structure including;
a pair of elongated gas-filled bladders adjacent each other, said bladders having a length and an inboard side extending along said length, said inboard side of each of said pair of bladders facing or abutting each other; and
at least one bleed channel in communication between said pair of bladders, said at least one bleed channel extending transverse to said length between said inboard side of each of said pair of bladders; and
an elongated outer covering encasing said plurality of bladder structures.

2. The patient positioner of claim 1, wherein the plurality of bladder structures includes upper, intermediate and lower bladder structures.

3. The patient positioner of claim 2, wherein said gas-filled bladders of said upper bladder structure are inflated to a lower pressure than the gas-filled bladders of said intermediate and lower bladder structures.

4. The patient positioner of claim 3, wherein said gas-filled bladders of said intermediate and lower bladder structures are inflated to the same pressure.

5. The patient positioner of claim 1, wherein each of said at least one bleed channel has an effective diameter of between ⅛- 3/16 inches.

6. The patient positioner of claim 1, wherein said at least one bleed channel includes three bleed channels evenly distributed along said length.

7. The patient positioner of claim 1, wherein said outer covering includes a single seam extending along said length of said bladder structures in each of the top and bottom surface, each single seam defining a channel in said covering to provide pathways for heat and moisture to escape between the body part of the patient resting on the positioner and said outer surface.

8. The patient positioner of claim 7, wherein each single seam is arranged over said at least one bleed channel.

9. The patient positioner of claim 7, further comprising an array of seams in the top and bottom surfaces of said covering, said array of seams including said single seam and a plurality of transverse seams extending across a width of said top and bottom surfaces perpendicular to said length, said plurality of transverse seams spaced apart along said length, said plurality of transverse seams each defining channels in top and bottom surfaces of said covering to provide pathways for heat and moisture to escape between the body part of the patient resting on the positioner and said outer surface.

10. The patient positioner of claim 9, wherein said array of seams includes four transverse seams.

11. The patient positioner of claim 9, wherein said array of seams includes a perimeter seam defined around a perimeter of said outer covering, said perimeter seam joining said upper and lower surfaces to completely encase said plurality of bladder structures.

12. The patient positioner of claim 1, wherein outer covering is formed of a vinyl, nylon or polyurethane material. The patient positioner of claim 1, wherein said pair of bladders of each of said plurality of bladder structures are formed of an elastomeric material.

14. The patient positioner of claim 13, wherein said elastomeric material is a vinyl, polyurethane, or a laminated fabric.

15. The patient positioner of claim 1, wherein the gas-filled bladders are filled with an inert gas.
